(19) United States
(12) Patent Application Publication
(10) Pub. No.: US 2011/0090274 A1
(43) Pub. Date: Apr. 21, 2011

(54) LIQUID EJECTING APPARATUS AND CONTROL METHOD OF LIQUID EJECTING APPARATUS

(75) Inventors: Nobutoshi Otsuka, Azumino-shi (JP); Hiroyuki Matsuo, Shiojiri-shi (JP)

(73) Assignee: SEIKO EPSON CORPORATION, Shinjuku-ku (JP)

(21) Appl. No.: 12/907,770

(22) Filed: Oct. 19, 2010

(30) Foreign Application Priority Data
Oct. 20, 2009 (JP) 2009-241120

(51) Int. Cl. B41J 29/38

(52) U.S. Cl. 347/10

(57) ABSTRACT

The driving signal generation section is able to generate a first ejection drive pulse for ejecting the first liquid and a second ejection drive pulse for ejecting the second liquid. The control section forms a pre-dot group in advance on a landing target area of the first liquid in the ejection target by ejecting the second liquid on the basis of the second ejection drive pulse, and subsequently forms a pattern dot on the landing target area, on which the pre-dot group is formed, by ejecting the first liquid on the basis of the first ejection drive pulse. In the apparatus, a total length of the pre-dot group in a direction of the relative movement is longer than a total length of the pattern dot in the direction of the relative movement.

The entire disclosure of Japanese Patent Application No: 2009-241120, filed Oct. 20, 2009 are expressly incorporated by reference herein.

### BACKGROUND

1. Technical Field

The present invention relates to a liquid ejecting apparatus having, for example, an ink jet type printing head and a control method thereof. In particular, the invention relates to a liquid ejecting apparatus capable of ejecting a first liquid for forming patterns, such as images and characters, on an ejection target and a second liquid, which reacts to the first liquid, and a control method of the liquid ejecting apparatus.

2. Related Art

Generally, liquid ejecting apparatuses have a liquid ejecting head so as to eject various kinds of liquid from the liquid ejecting head. As a representative example of the liquid ejecting apparatuses, for example, there are image printing apparatuses such as an ink jet type printing apparatus (hereinafter simply referred to as a printer) that has an ink jet type printing head (hereinafter simply referred to as a printing head) so as to perform printing by way of forming dots by ejecting and landing ink, in a liquid state as liquid droplets on a printing medium such as a printing paper serving as an ejection target, from the printing head. In recent years, the liquid ejecting apparatuses have not been limited to the image printing apparatus and have been applied to various manufacturing apparatuses such as display manufacturing apparatuses for example.

There are proposed various compositions of ink to be used in printing performed by the printer in the ink jet printing method. Recently, as demand for a high quality printed image has increased, in particular, various methods of further improving the properties of color generation and luster for printed images have been studied. For example, there is proposed a configuration in which, as a reaction liquid, a solution of multivalent metal salt (for example, magnesium sulfate) or a solution containing polyallylamine or a derivative thereof is ejected and landed on the printing medium, and subsequently an ink (ink composition) including pigments and resin emulsion is landed on the reaction liquid, causing them to react with each other (for example, refer to Japanese Patent 3206797). Other than that, there are proposed various ink jet printing methods capable of obtaining a fine image by using two liquids of a first liquid for forming patterns such as images and characters on the printing medium and a second liquid for facilitating fixation (cohesion) on the printing medium by reacting to the first liquid.

However, in the printing methods using the two liquids in the related art, in order to exhibit an effect of causing a more reliable reaction between them, for instance, the reaction liquid is landed on an area larger than an area on which the ink is landed, for example, the whole surface of the printing medium. In such a configuration, there is a problem in that the reaction liquid, in the part on which the ink is not landed, is wasted.

Further, a configuration is also conceivable where the reaction liquid is landed at only the position, at which the ink is landed, on the printing medium before the ejection of the ink. However, when the landing position of the reaction liquid is deviated from the landing position of the ink, a reactive part and a nonreactive part are generated. Thus, there is a problem in that the effect thereof is not sufficient.

### SUMMARY

An advantage of some aspects of the invention is to provide a liquid ejecting apparatus capable of improving the printing quality of a record while suppressing consumption of the second liquid and a control method of the liquid ejecting apparatus, in the configuration in which there is a first liquid for forming patterns on the ejection target and a second liquid reacting to the corresponding first liquid.

The invention has been proposed to achieve the advantage, and can be realized as the following configurations. According to an aspect of the invention, a liquid ejecting apparatus includes: a liquid ejecting head that allows a pressure generating section to cause a pressure change in liquid within a pressure chamber, ejects liquid from nozzles by using the pressure change, and lands the liquid on an ejection target; and a moving section that relatively moves the liquid ejecting head and the ejection target. With such a configuration, the liquid ejecting apparatus is able to eject a first liquid for forming a predetermined pattern on the ejection target and a second liquid reacting to the first liquid. In addition, the liquid ejecting apparatus also includes a driving signal generation section that generates a drive pulse for driving the pressure generating section; and a control section that controls application of the driving signal to the pressure generating section. The driving signal generation section is able to generate a first ejection drive pulse for ejecting the first liquid and a second ejection drive pulse for ejecting the second liquid. The control section forms a pre-dot group on a landing target area of the first liquid in the ejection target in advance by ejecting the second liquid on the basis of the second ejection drive pulse, and subsequently forms a pattern dot on the landing target area, on which the pre-dot group is formed, by ejecting the first liquid on the basis of the first ejection drive pulse. In the apparatus, a total length of the pre-dot group in a direction of the relative movement is longer than a total length of the pattern dot in the direction of the relative movement.

In addition, the term “reaction” means a reaction that facilitates fixation on the ejection target of the first liquid.

According to the aspect of the invention, since the second liquid is ejected only onto the landing target area of the liquid of the ejection target, consumption of the second liquid is reduced as compared with the configuration in which the second liquid is ejected onto the area larger than the area on which the second liquid is landed similarly to the related art. Further, the total length of the pre-dots, which are formed by the second liquid, in the direction of the relative movement becomes longer than the total length of the pattern dot in the direction of the relative movement. Thus, even when the landing position of the first liquid is slightly deviated from the landing position of the first liquid, it is possible to make the first liquid react to the pre-dot group of the second liquid which is formed in a wider range. As a result, it is possible to suppress the nonreactive part due to the difference in the landing position.

In the above-mentioned configuration, it is characterized that the pre-dot group includes a main dot that is formed by landing a main liquid droplet and a satellite dot that is formed by landing a satellite liquid droplet, which is generated at the time of ejecting the main liquid droplet, on a position which is deviated from a position of the main dot formed in the ejection target.

Further, in the above-mentioned configuration, it is preferable that the pattern dot of the first liquid should be formed in the range of the total length of the pre-dot group, which is previously formed on the landing target area, in the direction of the relative movement.

In the above-mentioned configuration, it is preferable that the pre-dot group should fill in the space between the pattern dots of the first liquid.

With such a configuration, the nonreactive part due to the difference in the landing position of the first liquid is more reliably suppressed.

In the above-mentioned configuration, it is preferable to adopt a configuration in which the liquid ejecting apparatus further includes a heating section and the heating section is provided out of the range in which the second liquid is ejected.

With such a configuration, since the heating section is provided out of the range in which the second liquid is ejected, it is possible to prevent the second liquid from drying before it reacts to the first liquid.

Further, according to another aspect of the invention, there is provided a liquid ejecting apparatus allowing a pressure generating section to cause a pressure change in liquid within a pressure chamber while moving relative to an ejection target, ejecting liquid from nozzles by using the pressure change, and landing the liquid on an ejection target. The liquid ejecting apparatus is configured to be able to eject a first liquid for forming a predetermined pattern on the ejection target and a second liquid reacting to the first liquid. The liquid ejecting apparatus includes: a driving signal generation section that generates a drive pulse for driving the pressure generating section; and a control section that controls application of the driving signal to the pressure generating section. The driving signal generation section is able to generate a first ejection drive pulse for ejecting the first liquid and the second ejection drive pulse for ejecting the second liquid. The second ejection drive pulse has at least an expansion element that changes an electric potential during a time period Pwc so as to expand the pressure chamber, an expansion-hold element that holds a terminal potential of the expansion element only during a time period Pwh, and a contraction element that changes the electric potential during a time period Pwd so as to contract the pressure chamber which is expanded by the expansion element. In the apparatus, durations of the elements satisfy the following conditions: (1) Pwc≦0.43×Tc, (2) Pwh≦0.41×Tc, and (3) Pwd≦0.40×Tc. Here, Tc is an oscillation cycle of pressure oscillation generated in the second liquid within the pressure chamber. The control section forms a pre-dot group on a landing target area of the first liquid in the ejection target in advance by ejecting the second liquid on the basis of the second ejection drive pulse, and subsequently forms a pattern dot on the landing target area, on which pre-dot group is formed, by ejecting the first liquid on the basis of the first ejection drive pulse.

In addition, “duration” means a time period from the beginning of the waveform element, which is applied to the pressure generating section, to the end thereof.

With such a configuration, since the second liquid is ejected only onto the landing target area of the liquid of the ejection target, consumption of the second liquid can be reduced as compared with the configuration in which the second liquid is ejected onto the area larger than the area on which the second liquid is landed as in the related art. Further, the durations of the elements of the second ejection drive pulse are set to satisfy the conditions (1) to (3). Thus, when the second liquid is ejected from the nozzles by using the corresponding second ejection drive pulse, it is possible to intentionally produce the satellite liquid droplet which is separated from the main liquid droplet of the second liquid and takes flight. Thereby, when the liquid droplet group is landed on the landing target area on the ejection target, the pre-dot group is formed of the main dot which is formed by landing the main liquid droplet and one or a plurality of satellite dots which is formed by landing the satellite liquid droplet at a position deviated from the landing position of the main dot toward the rear side. Further, the total length of the pre-dot group, which is formed in such a manner, in the direction of the relative movement becomes longer than the total length of the dots, which are formed by landing the first liquid, in the direction of the relative movement. Thereby, even when the landing position of the first liquid is slightly deviated from the landing position of the first liquid, it is possible to make the first liquid react to the pre-dot group of the second liquid which is formed in a wider range. Hence, it is possible to suppress the nonreactive part due to the difference in the landing position.

In the above-mentioned configuration, it is preferable that the durations of the elements of the second ejection drive pulse should satisfy at least any one of the following conditions: (4) Pwc≦0.40×Tc, (5) Pwh≦0.40×Tc, and (6) Pwd≦0.37×Tc.

With such a configuration, at least one of the conditions (4) to (6) is satisfied. Thus, when the second liquid is ejected by using the first ejection drive pulse, the flying speed of the liquid droplets further increases. Thereby, the total length of the satellite liquid droplet in the flying direction thereof becomes longer. As a result, the total length of the pre-dot group in the relative movement direction thereof becomes longer when the pre-dot group is landed on the ejection target. As a result, the nonreactive part due to the difference in the landing position of the first liquid is reduced.

Further, according to a further aspect of the invention, there is provided a method of controlling a liquid ejecting apparatus allowing a pressure generating section to cause a pressure change in liquid within a pressure chamber while relatively moving a liquid ejecting head and an ejection target, ejecting liquid from nozzles by using the pressure change, and landing the liquid on an ejection target. The method includes: a pre-dot-group formation process of forming a pre-dot group in advance on a landing target area of the first liquid for forming a predetermined pattern in the ejection target by ejecting the second liquid which reacts to the first liquid; and a pattern-dot formation process of forming a pattern dot on the landing target area, on which the pre-dot group is formed, by ejecting the first liquid on the basis of the first ejection drive pulse. In the method, a total length of the pre-dot group in a direction of the relative movement is longer than a total length of the pattern dot in the direction of the relative movement.

With such a configuration, since the second liquid is ejected only onto the landing target area of the liquid of the ejection target, consumption of the second liquid is reduced as compared with the configuration in which the second liquid is ejected onto the area larger than the area on which the second liquid is landed as in the related art. Further, the total length of the pre-dots, which are formed by the second liquid, in the direction of the relative movement becomes longer than the total length of the pattern dot in the direction of the relative movement. Thus, even when the landing position of the first liquid is slightly deviated from the landing position of the first liquid, it is possible to make the first liquid react to the pre-dot group of the second liquid which is formed in a wider range. Hence, the nonreactive part due to the difference in the landing position is suppressed.

### BRIEF DESCRIPTION OF THE DRAWINGS

FIG. 1 is a side view illustrating a schematic configuration of a printer.

FIG. 2A is a side view of a head unit.

FIG. 2B is a bottom view of the head unit.

FIG. 3 is a principal part sectional view illustrating a configuration of a printing head.

FIG. 4 is a block diagram illustrating an electric configuration of the printer.

FIG. 5A is a waveform diagram illustrating a configuration of a first ejection drive pulse.

FIG. 5B is a waveform diagram illustrating a configuration of a second ejection drive pulse.

FIG. 6A is a schematic diagram illustrating a state at the time of ejecting ink.

FIG. 6B is a schematic diagram illustrating a state at the time of ejecting reaction liquid.

FIG. 7A is a diagram illustrating a pattern dot which is formed by landing the ink.

FIG. 7B is a diagram illustrating a pre-dot group which is formed by landing the reaction liquid.

FIG. 8 is a diagram illustrating a situation in which dots are formed by landing the reaction liquid and the ink on a roll paper.

FIG. 9 is a top plan view illustrating a configuration of the printer according to a second embodiment of the invention.

### DESCRIPTION OF EXEMPLARY EMBODIMENTS

Hereinafter, an embodiment of the invention will be described with reference to the accompanying drawings. Furthermore, various limitations are applied to the following embodiments as preferred detailed examples of the invention, but the scope of the invention is not limited to these embodiments if there is no particular description limiting the invention. In addition, the embodiment describes, as an example, an image printing apparatus which is one type of liquid ejecting apparatus, specifically, an ink jet type printer (hereinafter referred to as a printer) equipped with an ink jet type printing head (hereinafter referred to simply as a printing head) as a liquid ejecting head.

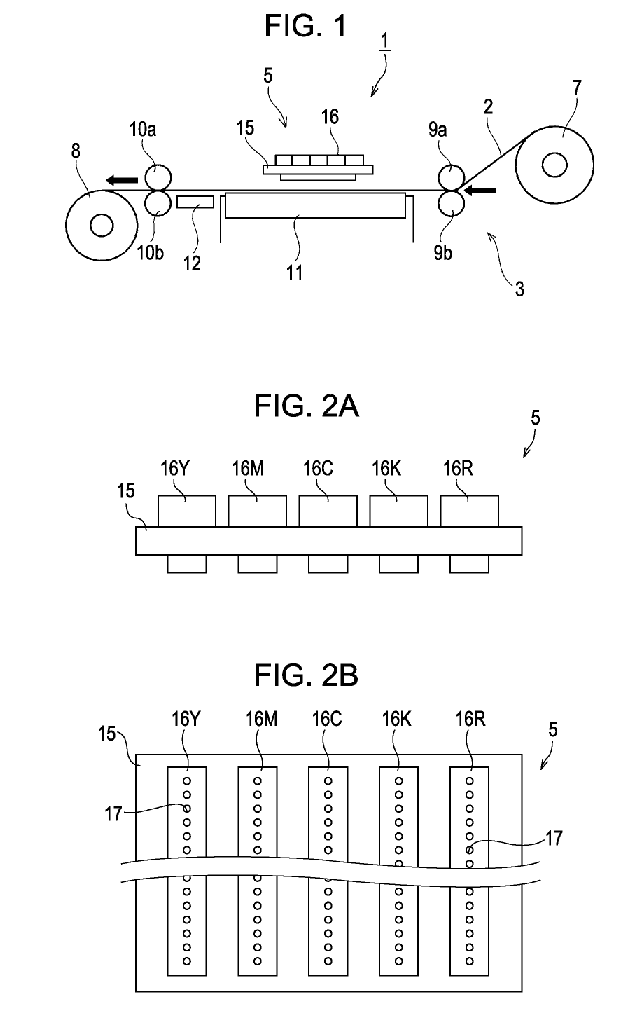

FIG. 1 is a schematic side view illustrating a schematic configuration of a printer 1 according to an embodiment of the invention. The printer 1 according to the embodiment is configured to print patterns such as characters and images on a band-like roll paper 2 (a continuous paper) which is a kind of printing medium (the ejection target) in an ink jet manner while relatively moving the roll paper 2 and a head unit 5 which is equipped with a plurality of printing heads.

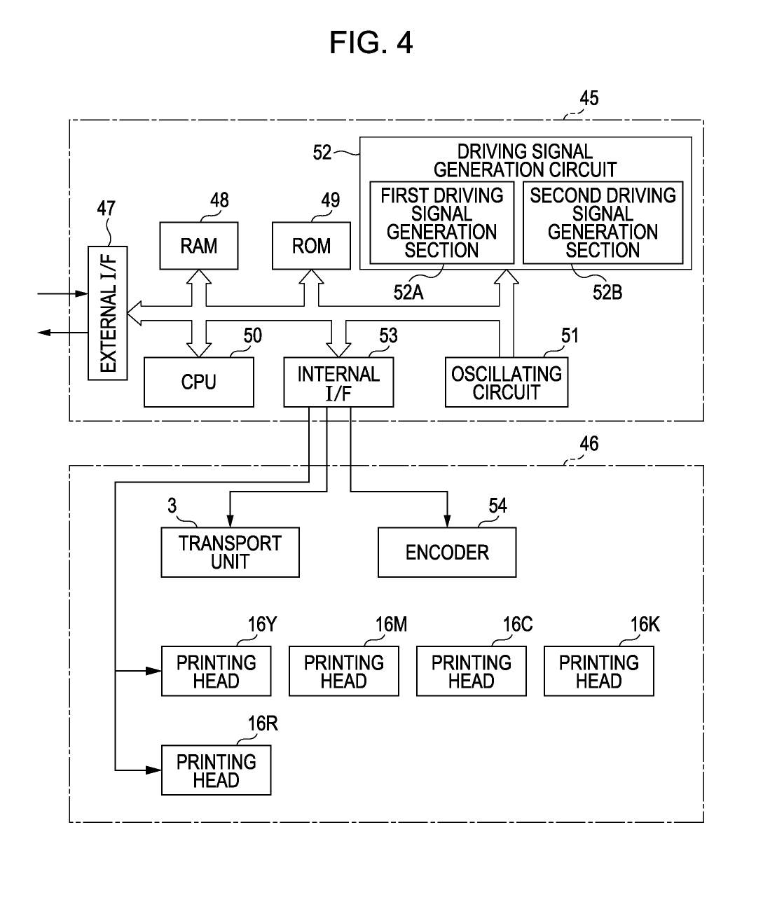

The printer 1 according to the embodiment is schematically configured to include a printer controller 45 (refer to FIG. 4), a transport unit 3, and a head unit 5. The transport unit 3 functions as a moving section in the embodiment of the invention, and transports the corresponding roll paper 2 in the continuous direction of the roll paper 2 from a supply roll 7, which is disposed upstream, to a wind-up roll 8 side on the downstream side (the direction indicated by the arrow in FIG. 1). The transport unit 3 includes a pair of upper and lower feeding rollers 9a and 9b, similarly a pair of upper and lower feed-out rollers 10a and 10b, a platen 11, and the like. The feeding rollers 9a and 9b are rotated by a driving motor, which is not shown, in a state where the roll paper 2 is nipped by the rollers, thereby continuously feeding out the roll paper 2 from the supply roll 7 and sending it to the platen 11 side as a printing region.

The platen 11 is a member that supports the roll paper 2 from the rear surface thereof opposite to the printing surface thereof on which the ink is landed during the printing operation. In the vicinity of the platen 11, specifically, between the platen 11 and the feed-out rollers 10a and 10b, a heater 12 (corresponding to the heating section according to the embodiment of the invention) is disposed. The heater 12 heats the printed roll paper 2 which is sent from the platen 11 side in order to facilitate drying of the printed image and the like on the roll paper 2. As described above, the heater 12 as the heating section is provided at least outside the range (that is, out of the printing region) in which the reaction liquid is ejected. Therefore, it is possible to prevent the reaction liquid (to be described later) from drying on the roll paper 2 before it reacts to the ink.

The feed-out rollers 10a and 10b are rotated by a driving motor which is not shown in a state where the roll paper 2 is nipped by the rollers, thereby winding up the printed roll paper 2 on the printing region side and feeding it out to a wind-up roll 8 side. The roll paper 2, which is fed out from the printing region, is wound around the wind-up roll 8.

The head unit 5 is fixedly disposed above the platen 11 during the printing operation, and ejects and lands the ink on the roll paper 2 which is sequentially transported onto the platen 11, thereby forming dots and printing an image and the like on the roll paper 2 with aggregation of the dots. That is, in the printer 1, the head unit 5 (printing heads 16) performs the printing operation while relatively moving the ejection target. The head unit 5 is formed to have printing heads 16 mounted on a carriage 15 which is a kind of a head holding member. In the printer 1 according to the embodiment, water-based pigment inks having four colors of yellow (Y), black (K), magenta (M) and cyan (C) are used as the ink (corresponding to the first liquid in the embodiment of the invention), and the reaction liquid (corresponding to the second liquid in the embodiment of the invention) for facilitating fixation of the inks on the roll paper 2 is used. As the reaction liquid, the reaction liquid satisfactorily reacting to the ink used in the printer 1, for example, a type of the reaction liquid containing a soluble multivalent metal salt is used.

In addition, the configuration, in which the ejection target is relatively moved by the head unit 5 (the printing heads 16), is not limited to, as exemplified by the embodiment, the configuration in which the position of the head unit 5 is fixed and the roll paper 2 as the ejection target is moved. It may be possible to adopt the configuration in which the head unit 5 is moved relative to the roll paper 2 in the continuous direction of the corresponding roll paper in a state where the position of the roll paper 2 is fixed, or the configuration in which the head unit 5 and the roll paper 2 are moved away from each other in the opposite directions. In the former configuration, the section for moving the head unit 5 functions as the moving section in the embodiment of the invention. In the later configuration, both of the section for moving the head unit 5 and the section for moving the roll paper 2 function as the moving section in the embodiment of the invention.

FIGS. 2A and 2B are diagrams illustrating the configuration of the head unit 5. FIG. 2A is a side view of the head unit 5. FIG. 2B is a top plan view of the head unit 5 viewed from the bottom side (the nozzle substrate side).

As shown in the drawings, the head unit 5 is equipped with the plurality of printing heads 16 respectively corresponding to the various inks and reaction liquids. That is, the head unit 5 is equipped with, in order from the upstream side of the roll paper 2 in the transport direction (corresponding to the direction of the relative movement), a total of five printing heads 16 of a printing head 16R which ejects a reaction liquid (R): a printing head 16K which ejects black ink (K), a printing head 16C which ejects cyan ink (C), a printing head 16M which ejects magenta ink (M), and a printing head 16Y which ejects yellow ink (Y).

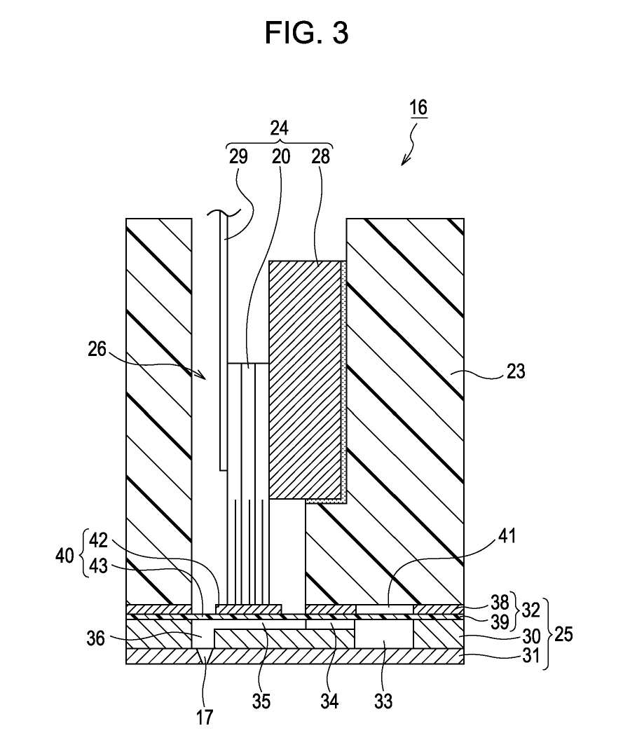

FIG. 3 is a principal part sectional view illustrating the configuration of the printing heads 16 as a representative example. Each printing head 16 includes a casing 23, an oscillator unit 24 which is housed in the casing 23, and a flow passage unit 25 which is bonded to the bottom surface (a leading end surface) of the casing 23. The casing 23 is, for example, made of epoxy based resin. The casing 23 has therein a housing hollow portion 26 for housing the oscillator unit 24. The oscillator unit 24 includes piezoelectric oscillators 20 which function as a kind of pressure generating section, a fixing plate 28 to which the piezoelectric oscillators 20 are bonded, and a flexible cable 29 which is for supplying driving signals and the like to the piezoelectric oscillators 20. The piezoelectric oscillators 20 are formed as a laminated type by dividing a piezoelectric plate, in which piezoelectric body layers and electrode layers are alternatively laminated, into a pectinate shape, and are vertically oscillating mode piezoelectric oscillators which are able to expand and contract (horizontal electric field effect type) in a direction orthogonal to a laminated direction (a direction of the electric field).

The flow passage unit 25 is configured by bonding the nozzle substrate 31 on one surface of the substrate of the flow passage substrate 30 and the oscillating plate 32 on the other surface of the flow passage substrate 30. The flow passage unit 25 is provided therein with a reservoir 33 (a common liquid chamber), a supply port 34, a pressure chamber 35, a nozzle communication port 36, and a nozzle 17. A serial liquid flow passage is formed corresponding to each nozzle 17. The liquid flow passage extends from the supply port 34 through the pressure chamber 35 and the nozzle communication port 36 to the nozzle 17 in series.

The nozzle substrate 31 is a thin plate, made of metal such as stainless steel, on which the nozzles 17 are arranged. On the nozzle substrate 31 of each printing head 16, the plurality of nozzles 17, which eject the ink (the reaction liquid in the case of the printing head 16R), are arranged in a direction orthogonal to the transport direction of the roll paper so as to constitute a nozzle array (a nozzle group). One nozzle array is formed of the plurality of nozzles 17 which are arranged at a formation pitch corresponding to, for example, 360 dpi. The number of the nozzles 17 constituting one nozzle array is determined so that the ink or the reaction liquid can be ejected in the range of the full width of the printing medium (the roll paper 2) of the maximum size which is compatible with the printer 1.

The oscillating plate 32 has a double layer structure in which an elastic film 39 is laminated on a surface of a supporting plate 38. In the embodiment, the supporting plate 38 is a stainless steel plate as a kind of metal plate, and the oscillating plate 32 is manufactured by using a composite plate which is formed by laminating the elastic film 39 as a resin film on the surface of the supporting plate 38. The oscillating plate 32 is provided with a diaphragm portion 40 for changing a volume of a pressure chamber 35. Further, the oscillating plate 32 is provided with a compliance portion 41 for sealing a part of the reservoir 33.

The diaphragm portion 40 is formed by partially removing the supporting plate 38 by the etching process and the like. Specifically, the diaphragm portion 40 includes insular portions 42 to which the tip end surfaces of the free end portions of the piezoelectric oscillators 20 are bonded and an elastic thin film portion 43 which is formed around the insular portions 42. The compliance portion 41 is formed by removing an area of the supporting plate 38 facing an opening surface of the reservoir 33 by the etching process and the like in the same manner as the diaphragm portion 40, and functions as a damper for absorbing fluctuation in pressure of the liquid stored in the reservoir 33.

In addition, since the tip end surfaces of the piezoelectric oscillators 20 are bonded to the insular portions 42, the volume of the pressure chamber 35 can be changed by expanding and contracting the free end portions of the piezoelectric oscillators 20. This change in volume causes change in liquid pressure within the pressure chamber 35. The printing head 16 is configured to eject the ink droplets or the reaction liquid droplets from the nozzles 17 by using the pressure change.

In addition, if only the printing head 16R, which ejects the reaction liquid, among the heads 16 is disposed at the end of the upstream side of the transport direction of the roll paper, there is no particular limitation in the arrangement order of the printing heads 16Y, 16M, 16C, and 16K which eject the ink.

Further, for example, it may be possible to adopt a configuration in which both of the ink and the reaction liquid are ejected from the same printing head. In the configuration, there is a concern that the ink and the reaction liquid, which are adhered to the surface and the like of the nozzle substrate 31, will become fixedly attached because of the reaction therebetween. However, in the embodiment, by separately providing the printing head for ejecting the ink and the printing head for ejecting the reaction liquid, it is possible to prevent the above-mentioned trouble.

FIG. 4 is a block diagram illustrating an electrical configuration of the printer 4. The printer 1 generally includes a printer controller 45 and a print engine 46. The printer controller 45 includes: an external interface (an external I/F) 47 which transmits and receives data to and from an external apparatus such as a host computer which is not shown; a RAM 48 which stores various data and the like; a ROM 49 which stores a control program for various data processing and the like; a CPU 50 (as a controller) which controls the whole system; an oscillating circuit 51 which generates a clock signal; a driving signal generation circuit 52 which generates a driving signal COM to be supplied to the printing head 16; and an internal interface 53 (an internal I/F 53) which transmits pixel data SI, the driving signal and the like to the print engine 46.

The external I/F 47 receives the print data such as image data from the host computer and the like. Further, the external I/F 47 outputs status signals such as a busy signal and an acknowledgement signal to the external apparatus. The RAM 48 is used as a receiving buffer, an intermediate buffer, an output buffer, a work memory, and the like. Further, the ROM 49 stores various control programs executed by the CPU 50, font data, graphic functions, various protocols, and the like. The print data includes various kinds of command data other than the image data to be printed. The term “command data” means data for instructing the printer to perform a specific operation. The command data includes, for example, command data that instructs the feeding of the roll paper 2, command data that represents the transport amount, and command data that instructs the discharging of the paper.

The CPU 50 functions as a control section in the embodiment of the invention. The CPU 50 outputs a head control signal for controlling the operation of each printing head 16 to the printing head 16, and outputs the control signal for generating the driving signal COM to the driving signal generation circuit 52. The head control signal includes, for example, a transfer clock CLK, a pixel data SI, a latch signal LAT, and a change signal CH. The latch signal and the change signal define the supply timing of the drive pulses constituting the driving signal COM.

Further, the CPU 50 generates, on the basis of the print data, the pixel data (the dot pattern data) SI, which is used in controlling the ejection of the printing head 16 for ejecting ink, through a color conversion process of converting the RGB color coordinate system into the CMY color coordinate system, a halftone process of reducing the multiple tone data to a predetermined tone, a dot pattern development process of developing the halftoned data in the dot pattern data by sorting the halftoned data in a predetermined arrangement for each ink color. The pixel data SI is data relating to the pixels for each ink color in the printed image, and is a kind of ejection control information. Further, the CPU 50 generates, on the basis of the print data, data SI′ which is used in controlling the ejection of the printing head 16 for ejecting the reaction liquid.

Here, “pixel” means a dot formation area virtually determined on the printing medium such as the roll paper 2 which is the ejection target, and the tone thereof is determined in response to the total amount of the ink landed on the area. In addition, the pixel data SI in the print data is generated from the data on presence/absence of the dots (or whether or not the ink is ejected), which are formed in the pixel area of the printing medium, and the size of the dots (or the amount of the ink ejected). In the embodiment, the pixel data SI includes 2-bit tone values. Accordingly, there are four types in the pixel data SI, that is, data [00] that corresponds to dot omission (slight oscillation), data [01] that corresponds to a small dot, data [10] that corresponds to a medium dot, and data [11] that corresponds to a large dot. Therefore, a printer according to the embodiment is able to form dots in four tone levels. In addition, the data SI′ for the reaction liquid is dot pattern data for forming dots at the positions (the ink landing target area on the printing medium), at which respective color dots are formed, by using the reaction liquid. In other words, it can be said that the data SI′ is dot pattern data before development for each ink color.

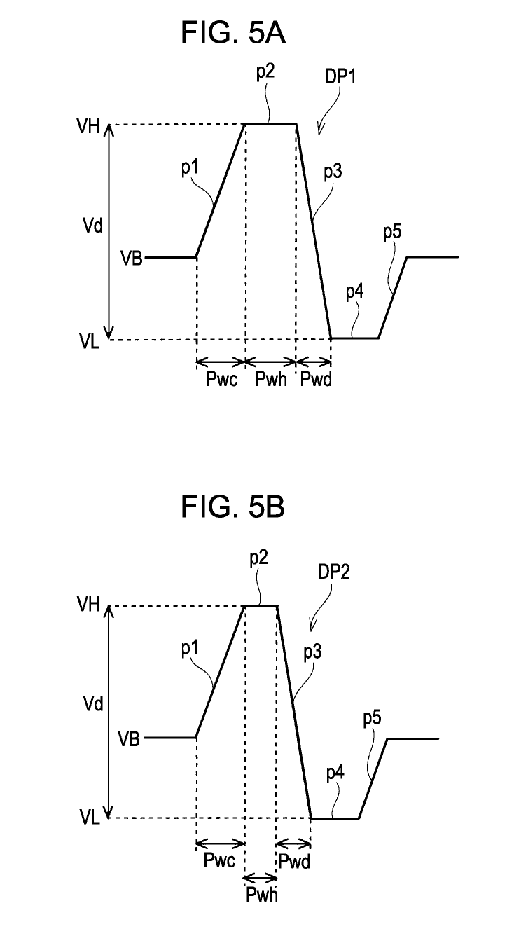

The driving signal generation circuit 52 includes the first driving signal generation section 52A and the second driving signal generation section 52B. The first driving signal generation section 52A is capable of generating the first driving signal COM1. The second driving signal generation section 52B is capable of generating the second driving signal COM2. The first driving signal COM1 is a driving signal used in the ejection of the ink, and includes an ejection drive pulse DP1 for ink shown in FIG. 5A. On the other hand, the second driving signal COM2 is a driving signal used in the ejection of the reaction liquid, and includes an ejection drive pulse DP2 for ink shown in FIG. 5B. The drive pulses DP1 and DP2 will be described in detail later.

Next, the print engine 46 is described below. As shown in FIG. 4, the print engine 46 includes the printing heads 16, a transport unit 3, an encoder 54 for checking the transport amount of the roll paper 2, and the like. The encoder 54 outputs an encoder pulse, which corresponds to the transport amount of the roll paper 2, as the information on the transport of the roll paper 2 to the CPU 50 through the internal I/F 53. The CPU 50 is able to detect the transport amount of the roll paper 2 on the basis of the encoder pulse which is received from the encoder 54 side.

FIGS. 5A and 5B are waveform diagrams illustrating configurations of the drive pulses in the embodiment. FIG. 5A shows the configuration of the first ejection drive pulse DP1 included in the first driving signal COM1. FIG. 5B shows the configuration of the second ejection drive pulse DP2 included in the second driving signal COM2. The first ejection drive pulse DP1 shown as an example is, for example, a drive pulse for ejecting the inks to the printing heads 16Y, 16M, 16C, and 16K. In the embodiment, the driving signal COM1 includes the plurality of (for example, three) first ejection drive pulses DP1 within a unit repetition cycle (single printing cycle) separated by the timing signals (LAT and the like) which is output on the basis of the encoder pulse from the encoder 54. Thus, in accordance with the number of the first ejection drive pulses DP1 supplied to the piezoelectric oscillator 20, it is possible to change the sizes of the dots which are formed in the pixel area. In other words, when a small dot is formed in the pixel area, a single first ejection drive pulse DP1 is applied to the piezoelectric oscillator 20 within the single printing cycle, thereby ejecting the ink from the nozzles 17 only once. Likewise, when a medium dot is formed in the pixel area, two first ejection drive pulses DP1 are successively applied to the piezoelectric oscillator 20 within the single printing cycle, thereby ejecting the ink from the nozzles 17 two times. In addition, when a large dot is formed in the pixel area, three first ejection drive pulses DP1 are successively applied to the piezoelectric oscillator 20 within the single printing cycle, thereby ejecting the ink from the nozzles 17 three times.

As shown in FIG. 5A, the first ejection drive pulse DP1 includes an expansion element p1, an expansion-hold element p2, a contraction element p3, a damping-hold element p4, and a damping element p5. The expansion element p1 is a waveform element that changes (increases) the electric potential from the intermediate potential VB (the reference potential) corresponding to the normal volume (the reference volume of expansion or contraction) of the pressure chamber 35 to the expansion potential VH during the time period Pwc. The expansion-hold element p2 is a waveform element that holds the expansion potential VH as the terminal potential of the expansion element p1 only during the time period Pwh. The contraction element p3 is a waveform element that changes (decreases) the electric potential from the expansion potential VH to the contraction potential VL during the time period Pwd. The damping-hold element p4 is a waveform element that holds the contraction potential VL as the terminal potential of the contraction element p3 during a predetermined period. Further, the damping element p5 is a waveform element that returns the electric potential at a certain slope from the contraction potential VL to the intermediate potential VB.

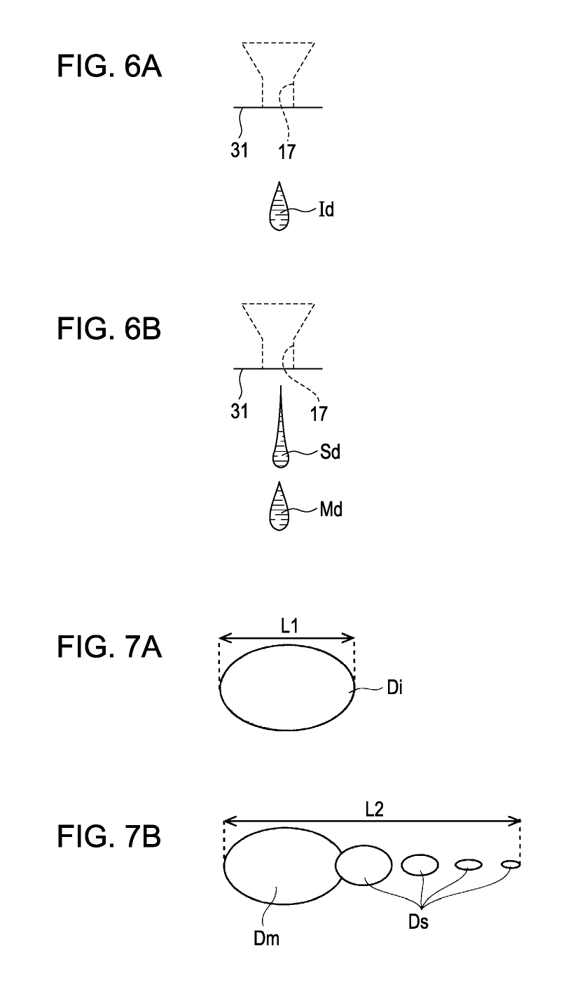

When the first ejection drive pulse DP1 configured as described above is supplied to the piezoelectric oscillator 20, first, the piezoelectric oscillator 20 is contracted by the expansion element p1, and thus the insular portion 42 of the diaphragm portion 40 is displaced in a direction of separating from the pressure chamber 35. Thereby, the pressure chamber 35 is expanded from the normal volume corresponding to the intermediate potential VB to the expansion volume corresponding to the expansion potential VH. This expansion draws the meniscus to the pressure chamber 35 side, and simultaneously the ink is supplied from the reservoir 33 side through the supply port 34 into the pressure chamber 35. Then, the expansion state of the pressure chamber 35 is held during the generation period (Pwh) of the expansion-hold element p2. Thereafter, by expanding the piezoelectric oscillator 20 in accordance with the application of the contraction element p3, the insular portion 42 is displaced to the pressure chamber 35 side. Thereby, the pressure chamber 35 is rapidly contracted from the expansion volume to the contraction volume corresponding to the contraction potential VL. This rapid contraction of the pressure chamber 35 pressurizes the ink within the pressure chamber 35, thereby ejecting the defined amount (for example, several ng to several tens of ng) of the ink (the ink droplet Id) from the nozzle 17 as shown in FIG. 6A. The contraction state of the pressure chamber 35 is held throughout the supply period of the damping-hold element p4, and in this period, the ink pressure within the pressure chamber 35, which is reduced by the ejection of the ink, increases again due to the natural oscillation thereof. In accordance with the increase timing, the damping element p5 is controlled to be supplied. By supplying the damping element p5, the pressure chamber 35 is expanded so as to return the volume thereof to the normal volume, and thus the change (residual oscillation) in ink pressure within the pressure chamber 35 is absorbed.

Here, the first ejection drive pulse DP1 is a drive pulse for printing patterns by using the ink. Hence, in order to improve the image quality of the printed image, the design is implemented to prevent the liquid droplet (the satellite ink droplet), which separates from the main part of the ejected ink (the main ink droplet) and takes flight, from being produced if possible. Specifically, when the ink is ejected from the nozzle 17, as the flying speed of the corresponding ink becomes high, the satellite ink droplet is more easily produced. For this reason, in order to suppress the flying speed of the ink to a range in which it has no influence on the image quality of the printed image, the following factors are determined: the amount of changed electric potential per the unit time period of the expansion element p1; the time period Pwh of the expansion-hold element p2; and the amount of changed electric potential per the unit time period of the contraction element p3. Further, in order to cope with the above, the printer 1 employs a method of minimizing the distance from the nozzle formation surface (the surface of the nozzle substrate 31 on the ejection side) of the printing head 16 at the time of the printing process to the printing surface of the printing medium on the platen 11. In the embodiment, the distance from the nozzle formation surface to the printing surface of the roll paper 2 as a printing medium is set to be, for example, 1.6 mm or less. Then, when the ink, which is ejected from the nozzle 17 by using the first ejection drive pulse DP1, is landed on the landing target area on the printing surface of the printing medium, as shown in FIG. 7A, the single circular or elliptical dots (the pattern dot) Di is formed.

As shown in FIG. 5B, in the embodiment, the second ejection drive pulse DP2 is, for example, a drive pulse for allowing the printing head 16R to eject the reaction liquid. The second ejection drive pulse DP2 includes, similarly to the first ejection drive pulse DP1, the expansion element p1, the expansion-hold element p2, the contraction element p3, the damping-hold element p4, and the damping element p5. However, the second ejection drive pulse DP2 is different from the first ejection drive pulse DP1 in that it is designed to be able to increase the flying speed of the reaction liquid droplet as compared with the case where the ink is ejected by using the first ejection drive pulse DP1. That is to say, the second ejection drive pulse DP2 is configured to intentionally produce the satellite liquid droplet at the time of ejecting the reaction liquid by increasing the flying speed of the reaction liquid droplet.

In order to increase the flying speed of the ejected liquid droplet, the duration of each element of the second ejection drive pulse DP2 should be set to satisfy the following conditions (1) to (3). In such a manner, it is possible to increase the flying speed Vm of the reaction liquid droplet to the extent that the satellite liquid droplet is produced. In addition, the driving voltages Vd of the first ejection drive pulse DP1 and the second ejection drive pulse DP2 (the electric potential difference between the expansion potential VH which is the maximum potential and the contraction potential VL which is the minimum potential) are set to be equal to each other.

Pwc≦0.43×Tc (1)

Pwh≦0.41×Tc (2)

Pwd≦0.40×Tc (3)

Here, Tc is the oscillation cycle of the pressure oscillation generated in the liquid (that is, the reaction liquid) within the pressure chamber 35 of the printing head 16R for ejecting the reaction liquid, and is uniquely defined by the shapes, sizes, and stiffness etc. of the constituent members such as the nozzle 17, the pressure chamber 35, the supply port 34, and the piezoelectric oscillator 20. The natural oscillation cycle Tc is represented by, for example, the following expression (A).

Tc=2π√[((Mn×Ms)/(Mn+Ms))×Cc] (A)

Here, in the expression (A), Mn is the inertance of the nozzle 17, Ms is the inertance of the supply port 34, and Cc is the compliance (which represents the volume change per unit pressure and the degree of softness) of the pressure chamber 35. Further, in the expression (A), the inertance M represents the mobility of the liquid in the flow passage such as the nozzle 17, in other words, the mass of the liquid per unit cross-sectional area. In addition, assuming that the density of the fluid is ρ, the cross-sectional area of the surface orthogonal to the downstream direction of the fluid in the flow passage is S, and the length of the flow passage is L, the inertance M can be approximately represented by the following expression (B).

M=(ρ×L)/S (B)

Furthermore, Tc is not limited to the definition given by the expression (A), and need only be the oscillation cycle of the pressure chamber of the printing head 16 for the reaction liquid.

As described above, on the basis of Tc, the duration of each element of the second ejection drive pulse DP2 is set. In such a manner, as shown in FIG. 6B, when the reaction liquid is ejected from the nozzle 17 by using the corresponding second ejection drive pulse DP2, it is possible to produce the satellite liquid droplet Sd which separates from the main liquid droplet Md of the reaction liquid and takes flight. With such a configuration, the liquid droplet group is landed on the landing target area on the printing surface of the printing medium. Then, as shown in FIG. 7B, the pre-dot group is formed of: the main dot Dm that is formed in a circular or elliptical shape by landing the main liquid droplet; and one or a plurality of satellite dots Ds that is formed by landing the satellite liquid droplet, which is separated from the main liquid droplet, on the position which is deviated to be close to the upstream side from the landing position of the main dot Dm in the transport direction of the roll paper. The total length L2 of the pre-dot group, which is formed as described above, in the transport direction of the roll paper becomes longer than the total length L1 of the dot Di, which is formed by landing the ink, in the transport direction of the roll paper. In the embodiment, in order to form the pre-dot group in the wider range on the printing medium, the durations of the elements of the second ejection drive pulse are set to satisfy at least any one of the following conditions.

Pwc≦0.40×Tc (4)

Pwh≦0.40×Tc (5)

Pwd≦0.37×Tc (6)

By making the durations of the elements of the second ejection drive pulse satisfy at least any one of the exemplified conditions (4) to (6), it is possible to further increase the flying speed of the reaction liquid droplet when the reaction liquid is ejected from the nozzle 17 by using the first ejection drive pulse DP1. Thereby, the total length of the satellite liquid droplet Sd in the flying direction becomes longer. As a result, the total length L2 of the pre-dot group in the transport direction at the time of the landing on the printing medium becomes longer.

Next, the operations of the printer 1 having the above-mentioned configuration will be described. When the printing operation is started, the transport unit 3 transports the roll paper 2 from the upstream side (the supply roll 7 side) to the downstream side (the wind-up roll 8 side) on the platen 11. While the printing head 16 and the roll paper 2 are relatively moved during the transport, the ink or the reaction liquid is ejected from the nozzles 17 of each printing head 16. The printing heads 16Y, 16M, 16C, and 16K for ejecting the inks eject the inks from the nozzles 17 by using the first ejection drive pulse DP1 on the basis of the pixel data SI. Further, the printing head 16R for ejecting the reaction liquid ejects the reaction liquid from the nozzles 17 by using the second ejection drive pulse DP2 on the basis of the data SI′ for the reaction liquid. In the embodiment, before the ink is ejected, the pre-dot group is formed by ejecting the reaction liquid from the printing head 16R for ejecting the reaction liquid in the ink landing target area on the printing surface of the roll paper 2 (pre-dot group formation process).

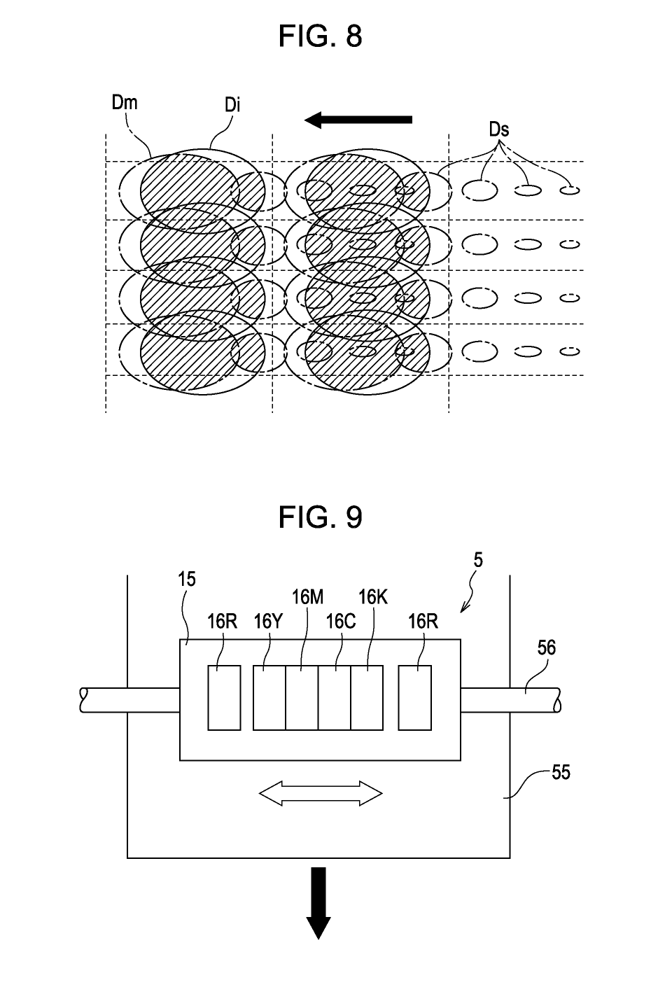

FIG. 8 is an enlarged view illustrating the situation in which the dots are formed by landing the reaction liquid and the ink on the roll paper 2 as the printing medium. In the drawing, the areas surrounded by the dashed lines are the landing target areas of the ink, and the direction indicated by the arrow is the transport direction of the roll paper 2. Further, the dots indicated by the chain lines are the dots of the reaction liquid (pre-dot group Dm, Ds), and the dots indicated by the solid lines are the dots of the ink (pattern dot Di). As shown in the drawing, when the reaction liquid is ejected from the nozzles 17 by using the second ejection drive pulse DP2, the reaction liquid droplet is separated into the main liquid droplet Md and the satellite liquid droplet Sd, and the liquid droplet group flies toward the printing surface of the roll paper 2 with its tail trailing behind. At this time, since the printing head 16 and the roll paper 2 are relatively moved, the liquid droplet group flies to be oblique to the printing surface of the roll paper 2. Hence, the liquid droplet groups land away from each other on the roll paper 2, and as shown in FIG. 8, the pre-dot groups formed by the liquid droplet groups become long in the transport direction of the roll paper 2. In addition, in the embodiment, since the distance from the nozzle formation surface to the printing surface of the roll paper 2 is set to be 1.6 mm or less, the difference in positions of the dots landed on the printing surface becomes unlikely to occur. However, when the reaction liquid is ejected from the nozzles 17 by using the first ejection drive pulse DP1, the satellite liquid droplet Sd is intentionally produced. Therefore, it is possible to form each pre-dot group in the wider range on the roll paper 2.

Subsequently, the inks of the respective colors are sequentially ejected by using the first ejection drive pulse DP1 to the landing target area on which the pre-dot group is formed, thereby forming the pattern dot Di (pattern dot formation process). As described above, the flying speed of the inks ejected by using the first ejection drive pulse DP1 makes it difficult to produce the satellite liquid droplet and trailing tail. Hence, the pattern dot Di, which is formed by landing the ink on the printing surface of the roll paper 2, is formed in the range of the total length of the pre-dot group Dm and Ds. Thereby, the pre-dot group which is formed in advance, that is, the reaction liquid, reacts to the ink which is landed thereon (the hatched part in FIG. 8), thereby facilitating the fixation of the ink on the roll paper 2. As a result, it is possible to suppress exudation and unevenness of the printed image, and it is possible to suppress color mixture at the boundary between different colors. Thus, it is possible to obtain a high-quality image.

As described above, by landing the inks of the respective colors onto the landing target areas on which the pre-dot groups are formed, the pattern dots are arranged in the widthwise direction of the roll paper 2, that is, the direction (the direction of the nozzle array) orthogonal to the transport direction of the roll paper. By using these pattern dot groups, the ruled line, which extends in the widthwise direction of the roll paper 2, is printed. By continuing the ruled line along the transport direction of the roll paper, patterns such as images and texts are printed on the roll paper 2.

The printer 1 according to the embodiment of the invention is configured so that the reaction liquid is ejected only onto the landing target area of the ink of the roll paper 2 as a printing medium. Hence, as compared with the configuration in which the reaction liquid is ejected onto the area larger than the area on which the ink is landed as in the related art, it is possible to reduce consumption of the reaction liquid. Further, the printer 1 is configured so that the total length L2 of the pre-dot group Dm and Ds of the reaction liquid in the transport direction of the roll paper becomes longer than the total length Li of the pattern dot Di in the transport direction of the roll paper. Thus, even when the landing position of the first liquid is slightly deviated from the landing position of the ink, it is possible to make the ink react to the pre-dot group of the reaction liquid which is formed in the wider range. Hence, it is possible to suppress occurrence of the nonreactive part due to the difference in the landing position. That is, when the reaction liquid is ejected, by intentionally making it easy to produce the satellite liquid droplet and the trailing tail thereof, it is possible to fill the gaps of the pattern dots on the roll paper 2 with the pre-dot groups. In such a manner, it is possible to more effectively suppress the nonreactive part due to the difference in the landing position of the ink.

FIG. 9 is a top plan view illustrating the configuration of the printer according to a second embodiment of the invention. The printer of the second embodiment is different from that of the first embodiment in the following point: the ink or the reaction liquid is ejected onto the printing paper 55 from each printing head 16 while the head unit 5 is scanned back and forth along the guide shaft 56 provided in the widthwise direction (which correspond to the direction indicated by the outlined arrow in the drawing, that is, the direction of the relative movement in the embodiment of the invention) of the printing paper 55 as a printing medium. In this configuration, in relation to the arrangement of the printing heads 16 in the carriage 15 of the head unit 5, in order to position the printing heads 16R, which eject the reaction liquid, among the printing heads 16 at the end of the line in the head scanning direction regardless of whether the path is outgoing or returning, the printing heads 16R are disposed at both end portions of the printing heads 16Y, 16M, 16C, and 16K which eject the inks in the head scanning direction thereof. In addition, the arrangement order of the printing heads 16Y, 16M, 16C, and 16K is not limited to the above-mentioned example.

In addition, the embodiments of the invention can be applied to other liquid ejecting heads such as a color material ejecting head used for manufacturing color filters of the liquid crystal display and the like, an electrode material ejection printing head used for manufacturing the electrodes of an organic EL (Electro Luminescence) display, an FED (Field Emission Display) and the like, and a bio-organic material ejecting head used for manufacturing bio chips (bio-chemical devices). In addition, the embodiments of the invention can be applied to the liquid ejecting apparatuses having the above-mentioned liquid ejecting heads. In the display manufacturing apparatus, the solutions of the color materials of R (Red), G (Green), and B (Blue) are ejected from the color material ejecting head. Further, in the electrode manufacturing apparatus, the liquid electrode material is ejected from the electrode material ejecting head. In the chip manufacturing apparatus, the solution of the bio-organic material is ejected from the bio-organic ejecting head.

What is claimed is:

1. A liquid ejecting apparatus comprising:
a liquid ejecting head that allows a pressure generating section to cause a pressure change in liquid within a pressure chamber, ejects liquid from nozzles by using the pressure change, and lands the liquid on an ejection target;
a moving section that relatively moves the liquid ejecting head and the ejection target;
a driving signal generation section that generates a drive pulse for driving the pressure generating section; and
a control section that controls application of the driving signal to the pressure generating section,
wherein the liquid ejecting apparatus is configured to be able to eject a first liquid for forming a predetermined pattern on the ejection target and a second liquid reacting to the first liquid,
wherein the driving signal generation section is able to generate a first ejection drive pulse for ejecting the first liquid and the second ejection drive pulse for ejecting the second liquid,
wherein the control section forms a pre-dot group in advance on a landing target area of the first liquid in the ejection target by ejecting the second liquid on the basis of the second ejection drive pulse, and subsequently forms a pattern dot on the landing target area, on which the pre-dot group is formed, by ejecting the first liquid on the basis of the first ejection drive pulse, and
wherein a total length of the pre-dot group in a direction of the relative movement is longer than a total length of the pattern dot in the direction of the relative movement.

2. The liquid ejecting apparatus according to claim 1, wherein the pre-dot group includes a main dot that is formed by landing a main liquid droplet and a satellite dot that is formed by landing a satellite liquid droplet, which is generated at the time of ejecting the main liquid droplet, on a position which is deviated from a position of the main dot formed in the ejection target.

3. The liquid ejecting apparatus according to claim 1, wherein the pattern dot of the first liquid is formed in the range of the total length of the pre-dot group, which is formed in advance on the landing target area, in the direction of the relative movement.

4. The liquid ejecting apparatus according to claim 1, wherein the pre-dot group fills in the space between the pattern dots of the first liquid.

5. The liquid ejecting apparatus according to claim 1, further comprising a heating section,
wherein the heating section is provided outside the range in which the second liquid is ejected.

6. A liquid ejecting apparatus allowing a pressure generating section to cause a pressure change in liquid within a pressure chamber while moving relative to an ejection target, ejecting liquid from nozzles by using the pressure change, and landing the liquid on an ejection target, the liquid ejecting apparatus comprising:
a driving signal generation section that generates a drive pulse for driving the pressure generating section; and
a control section that controls application of the driving signal to the pressure generating section,
wherein the liquid ejecting apparatus is configured to be able to eject a first liquid for forming a predetermined pattern on the ejection target and a second liquid reacting to the first liquid,
wherein the driving signal generation section is able to generate a first ejection drive pulse for ejecting the first liquid and the second ejection drive pulse for ejecting the second liquid,
wherein the second ejection drive pulse has at least an expansion element that changes an electric potential during a time period Pwc so as to expand the pressure chamber, an expansion-hold element that holds a terminal potential of the expansion element only during a time period Pwh, and a contraction element that changes the electric potential during a time period Pwd so as to contract the pressure chamber which is expanded by the expansion element,
wherein durations of the elements satisfy the following conditions:
Pwc≦0.43×Tc (1),
Pwh≦0.41×Tc (2), and
Pwd≦0.40×Tc (3),
where Tc is an oscillation cycle of pressure oscillation generated in the second liquid within the pressure chamber, and
wherein the control section forms a pre-dot group in advance on a landing target area of the first liquid in the ejection target by ejecting the second liquid on the basis of the second ejection drive pulse, and subsequently forms a pattern dot on the landing target area, on which the pre-dot group is formed, by ejecting the first liquid on the basis of the first ejection drive pulse.

7. The liquid ejecting apparatus according to claim 6, wherein the duration of the elements of the second ejection drive pulse satisfy at least any one of the following conditions:
Pwc≦0.40×Tc (4),
Pwh≦0.40×Tc (5), and
Pwd≦0.37×Tc (6).

8. A method of controlling a liquid ejecting apparatus allowing a pressure generating section to cause a pressure change in liquid within a pressure chamber while relatively moving a liquid ejecting head and an ejection target, ejecting liquid from nozzles by using the pressure change, and landing the liquid on an ejection target, the method comprising:
forming a pre-dot group in advance on a landing target area of the first liquid for forming a predetermined pattern in the ejection target by ejecting the second liquid which reacts to the first liquid; and
forming a pattern dot on the landing target area, on which the pre-dot group is formed, by ejecting the first liquid on the basis of the first ejection drive pulse,
wherein a total length of the pre-dot group in a direction of the relative movement is longer than a total length of the pattern dot in the direction of the relative movement.
